(19) United States
(12) Patent Application Publication
(10) Pub. No.: US 2016/0364387 A1
(43) Pub. Date: Dec. 15, 2016

(54) METHOD AND SYSTEM FOR ORGANIZING AND DISPLAYING LINKED TEMPORAL OR SPATIAL DATA

(71) Applicant: Joel A DiGirolamo, Lexington, KY (US)

(72) Inventor: Joel A DiGirolamo, Lexington, KY (US)

(21) Appl. No.: 14/734,519

(22) Filed: Jun. 9, 2015

(51) Int. Cl. G06F 17/30; G06F 3/0485; G06F 3/0482; G06F 3/0484

(52) U.S. Cl. CPC G06F 17/30011; G06F 17/30554; G06F 17/30516; G06F 3/04842; G06F 17/3053; G06F 17/30601; G06F 3/0485; G06F 3/0482; G06F 17/30867

(57) ABSTRACT

A method and apparatus for organizing and displaying linked temporal or spatial data for rapid search and retrieval. In order to provide users the capability of moving forward and backward in time through linked documents in a research stream, the system of the invention accesses or stores information regarding reference documents that a main document cites. In most cases, the reference documents were main documents at the time they were written and thus, have their own reference documents. For this reason, the system of the present invention stores or accesses information regarding all documents as well as cited reference documents.

### TECHNICAL FIELD

The present invention generally relates to document management and more particularly, is directed to a method and system for managing searchable documents and files.

### BACKGROUND

Since the dawn of the computer age, the amount of information created by humankind has continued to increase at a rapid rate. In 2011 alone, it was estimated that 1.8 trillion gigabytes of data were created. The age of big data has arrived and presents substantial challenges to managing data in a meaningful way so that it can be easily searched and used.

Scientists, engineers, scholars, historians and others spend a great deal of time searching through reams of data for various purposes. Much of this data is stored in the form of reports, journal articles and the like that are referenced and cross-referenced in computer databases. Academic documents from peer-reviewed journals are an important source of scholarly research.

These databases can usually be searched using keyword phrases which return hits of documents which include those keyword phrases. In most cases, the returned documents reference other documents related to the same subject matter. The reference documents then become of interest and the researcher must conduct further searches to locate each referenced document or click on links to bring them up for review. The reference documents likely refer to other relevant documents that the researcher must review.

As known in the prior art, the search process is one where each document must be treated as an independent and disconnected search and review with no convenient way to seamlessly move back and forth between a plurality documents in the same search stream.

Thus, there is a need in the prior art for a better solution to searching and reviewing documents in a search stream.

### SUMMARY OF THE INVENTION

Researchers typically encounter several problems as they explore a given area of research. Typically, the first problem is to find relevant research on the topic in question. Once the first research report is found on the topic, the researcher encounters a second problem, which is finding research upon which the first research report is built and quickly exploring that research.

Providing a researcher with the ability to access related documents backward in time or forward in time will greatly enhance their productivity. More generally, utilizing data object links, whether temporal, spatial, or otherwise, the present invention serves up these links to a researcher or consumer in a manner that allows for rapid comprehension and exploration.

The present invention provides a computer driven database content management system with a user interface. Each database entry is a reference to a document or work and either the reference itself is stored in the database or a link to it is stored. Thus, the documents may be stored in a remote database, i.e., on a file server on the Internet or on a website.

In accordance, with the present invention, as the researcher finds documents of interest, they can be added to the researcher's search stream, allowing the researcher to seamlessly move backwards and forwards in time between documents within the search stream. The researcher may have multiple search streams, one for each research project. A large research project may have a parent search stream with a number of child search streams, each one focusing on a particular aspect of the research project.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is an illustration of typical research documents with citations to other references contained within the documents as known in the art;

FIG. 2 is an illustration of the streams, or paths, which researchers may use to traverse through research documents in accordance with one embodiment of the present invention;

FIG. 3 is an illustration of the preferred embodiment of the invention within a website and backend database, presenting document citations and references to the user;

FIGS. 4 and 5 are illustrations of the present invention showing a main document search stream;

FIG. 6 is an illustration of a further embodiment of the present invention showing a main document search stream and a reference document search stream;

FIG. 7 is a flow chart illustrating the operation of one embodiment of the present invention;

FIG. 8 is a block diagram of one embodiment of a research portal in accordance with the present invention; and

FIGS. 9-11 are screen shots of the operation of the search and document review system of the present invention implemented on a smart phone device.

### DESCRIPTION OF THE PREFERRED EMBODIMENT

A preferred embodiment of the present invention will be described with reference to the figures.

In the preferred embodiment of the invention, in order to provide users the capability of moving through a stream of research forward and backward in time, the system of the invention accesses or stores information regarding reference documents that the main document cites. In most cases, the reference documents were main documents at the time they were written and thus, have their own reference documents. For this reason, the system of the present invention stores or accesses information regarding all documents as well as cited reference documents.

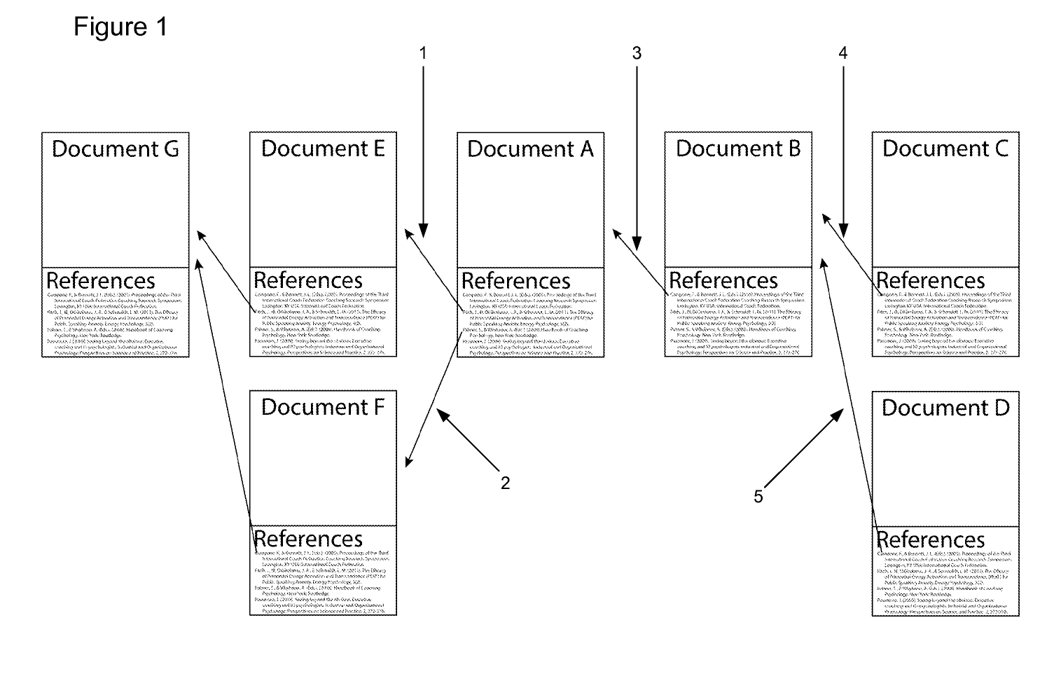

FIG. 1 illustrates how main documents and reference documents are often linked. As shown in FIG. 1, main document A references reference documents E and F as indicated by outgoing arrows 1 and 2.

Document B may be considered a main document, referencing reference Document A, as indicted by outgoing arrow 3. This illustrates how a document may be both a main document as well as a reference document, depending on where in the research process the researcher is at the time.

Similarly, documents C and D may be considered main documents which reference document B, as indicated by outgoing arrows 4 and 5.

FIG. 1 makes it clears that the same document can be a main document and also be a reference document to other documents that were created later in time.

In order to easily follow a stream of research, it is helpful to have the capability to visually see all of the links backward and forward in time and click to have access to any document within the stream.

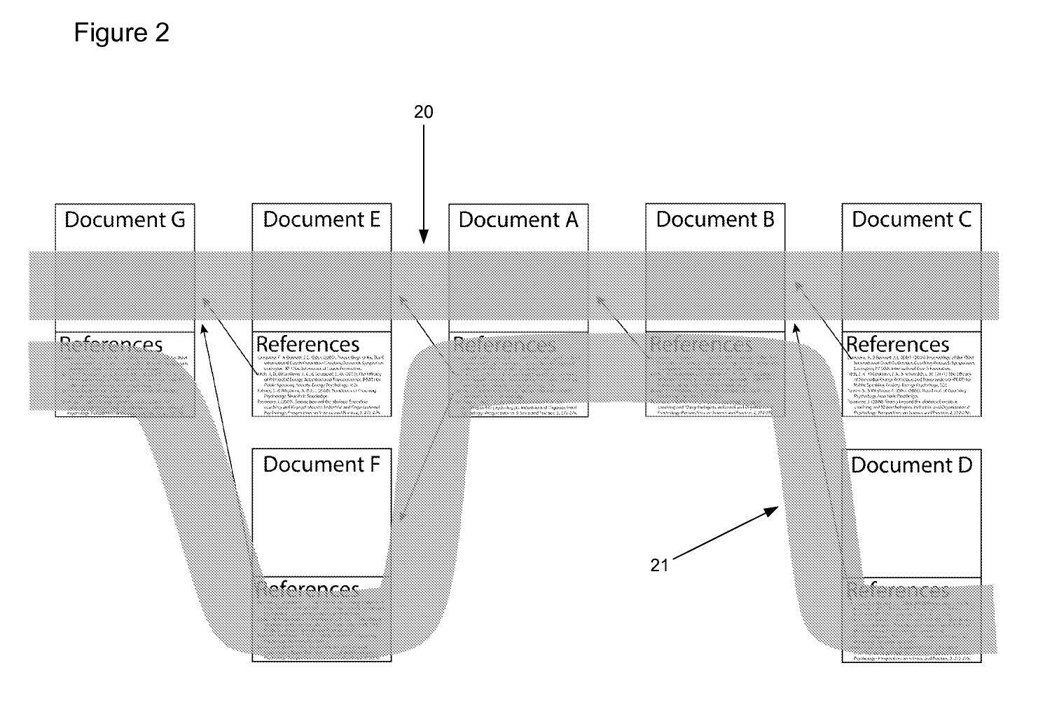

FIG. 2 illustrates two paths or streams, through research documents as indicated by the wide grey lines 20 and 21. The present invention creates a fast and simple way for a researcher to move from document to document, which does not currently exist in the art.

In the present invention, the documents may be entered into the database manually or automatically imported with a software interface to search engines, such as Google Scholar, that indexes the full text or metadata of scholarly literature, or accessed online in real time or cached.

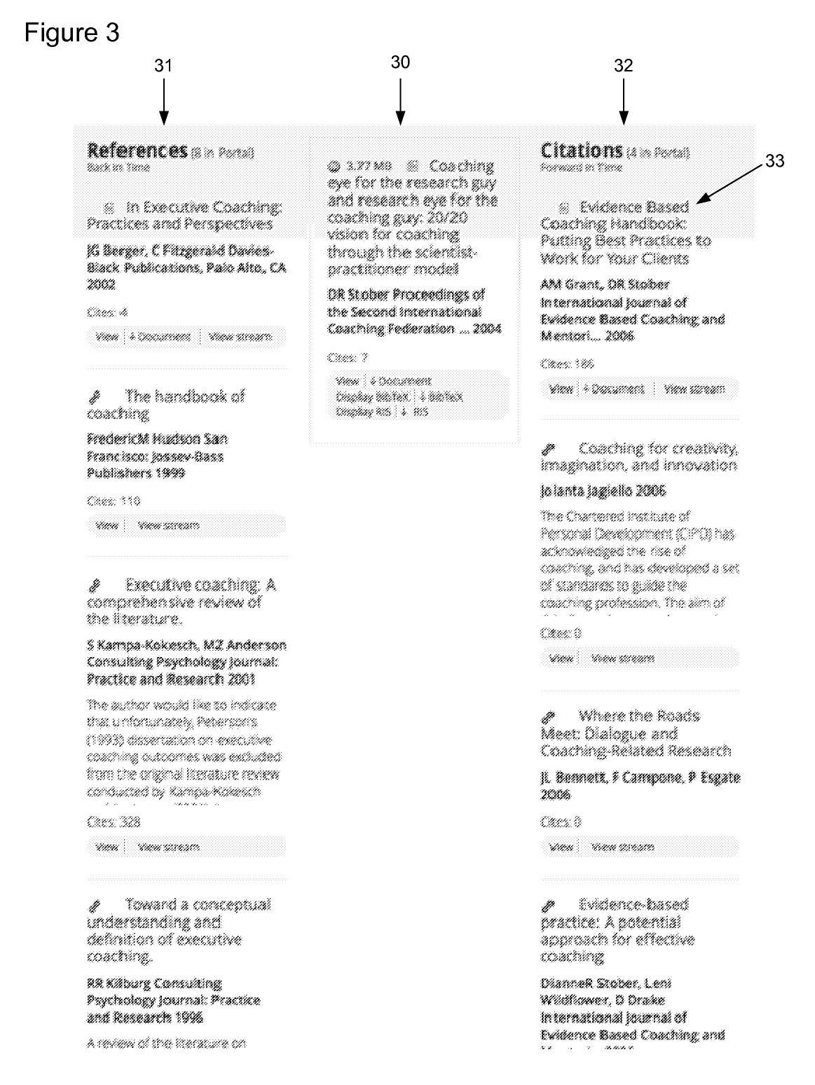

In the preferred embodiment of the invention, the documents may be displayed to the user with the main document in a middle column as illustrated in FIG. 3 by arrow 30, and reference documents in a column to the left as indicated by arrow 31. The column of references displayed in column 31 may be scrollable in order for the user to quickly access any one of the referenced documents. The user may click on one of the referenced documents, which would move it to the middle column and it would become the new main document. New reference documents linked to the new main document will then appear as column 31.

Similarly, when a main document is displayed in the middle column 30, documents which reference the main document will be displayed in the right-hand column 32 so the user may scroll through them for rapid access and retrieval. In the event that the user clicks on the document indicated as 33, it would become the new main document. In this manner a user may quickly move through documents in time, or temporally, displaying documents as a main document and reviewing reference documents and citing documents for rapid access.

While the preferred embodiment of the present invention describes document links, another further embodiment exists in the form of a contact manager system which links other types of data objects such as meeting calendar entries, meeting notes, telephone calls, or e-mails based upon temporal, topical keywords, or other relationships. Further, a contact manager embodiment may link individual contacts to other contacts in order to illustrate and access the stream of contact links.

For example, contact A may have introduced the user to contacts B and C, and contact C may have introduced the user to contact D. As the user reviews contact links and streams of relationships from one contact to another, it will be readily apparent which contacts have been the most fruitful.

Another embodiment of the present invention involves linking known in the art as social networks. In this embodiment, an individual would be displayed as the main individual with linked individuals in an adjacent, scrollable column, allowing for rapid viewing and retrieval of individual social links. Such a system and method of display provides significant utility in areas of organizational development and forensic analysis such as the analysis of terrorist networks and genealogy mapping.

Since an important aspect of research is the ability to temporarily stop work in one area to focus on another, stream searches with specific main documents may be saved and recalled for quick review or continuation of work.

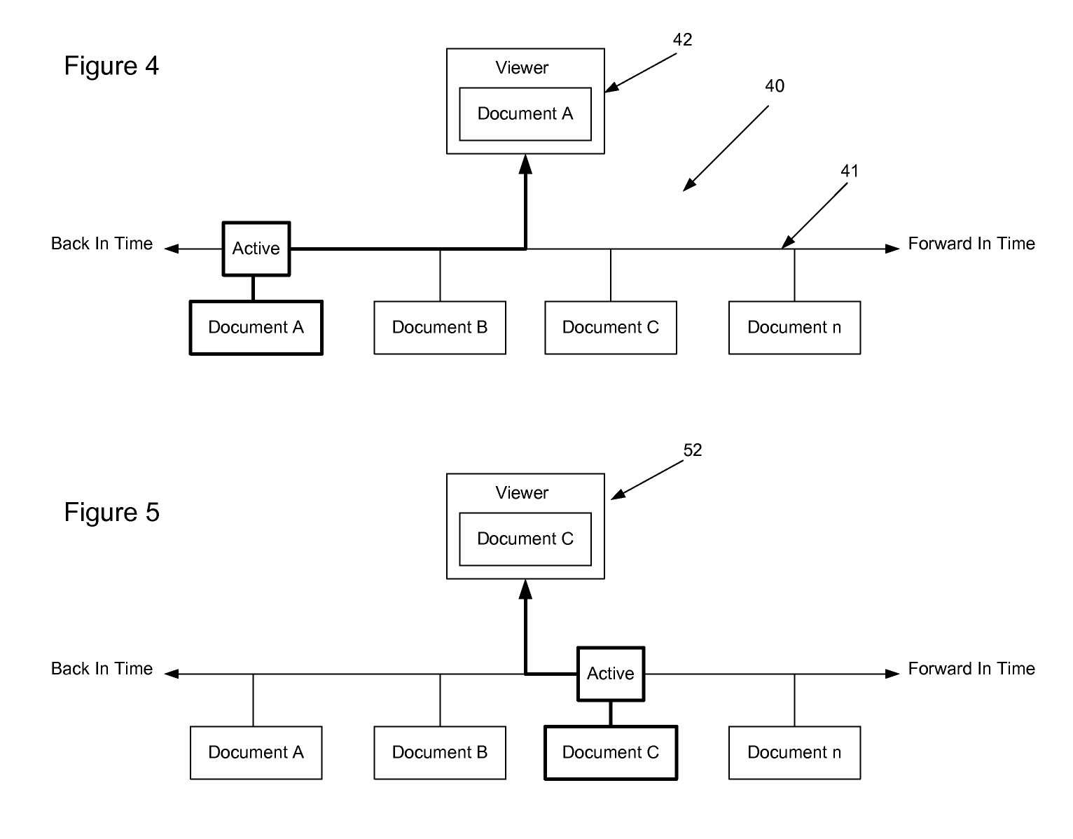

FIG. 4 illustrates a further embodiment of a research system 40 for managing searchable documents. The system includes a search stream 41 to which a plurality of documents A-n are added as a researcher finds documents of interest. As shown in FIG. 4, the researcher can scroll back and forth in time to view each document in the stream on a viewing station 42. Viewing station 42 can be a desktop computer, laptop, tablet, smartphone or any other device that allows viewing of an electronic file.

The sequential arrangement of documents in search stream 41 can be in the order inserted into the search stream by the researcher or be in chronological order based on the date and time that the documents were created.

As shown in FIG. 4, document A is active and is presented for viewing on viewing station 42. In FIG. 5, document C is active and is presented for viewing on viewing station 52.

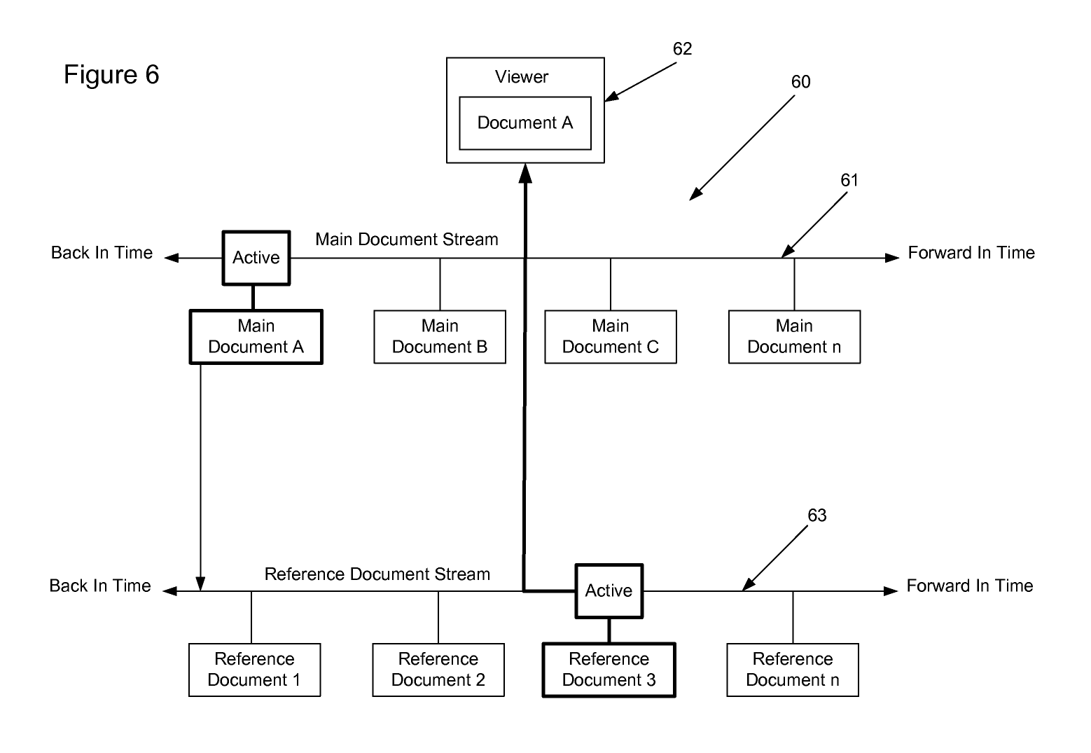

As many documents will cite references to other documents as resources, FIG. 6 illustrates a further system 60 of the present invention. As shown in FIG. 5, reference documents can be added to a reference document search stream.

As shown in FIG. 6, a researcher has selected main document A for viewing in main document stream 61. However, main document A cites a number of references documents 1-n which appear in reference document stream 63. Thus, while main document A is active, the researcher can scroll through each reference document in reference document stream 61 without losing his place in main document stream 61. As shown in FIG. 6, reference document 3 of main document A has been selected for viewing by the researcher.

When the researcher wishes to scroll to the next main document in main document stream 61, the reference documents cited in that main document will appear in reference document stream 63 for viewing as the researcher scrolls back and forth in time along stream 61. The reference documents may then be viewed by the researcher scrolling along reference document stream 63.

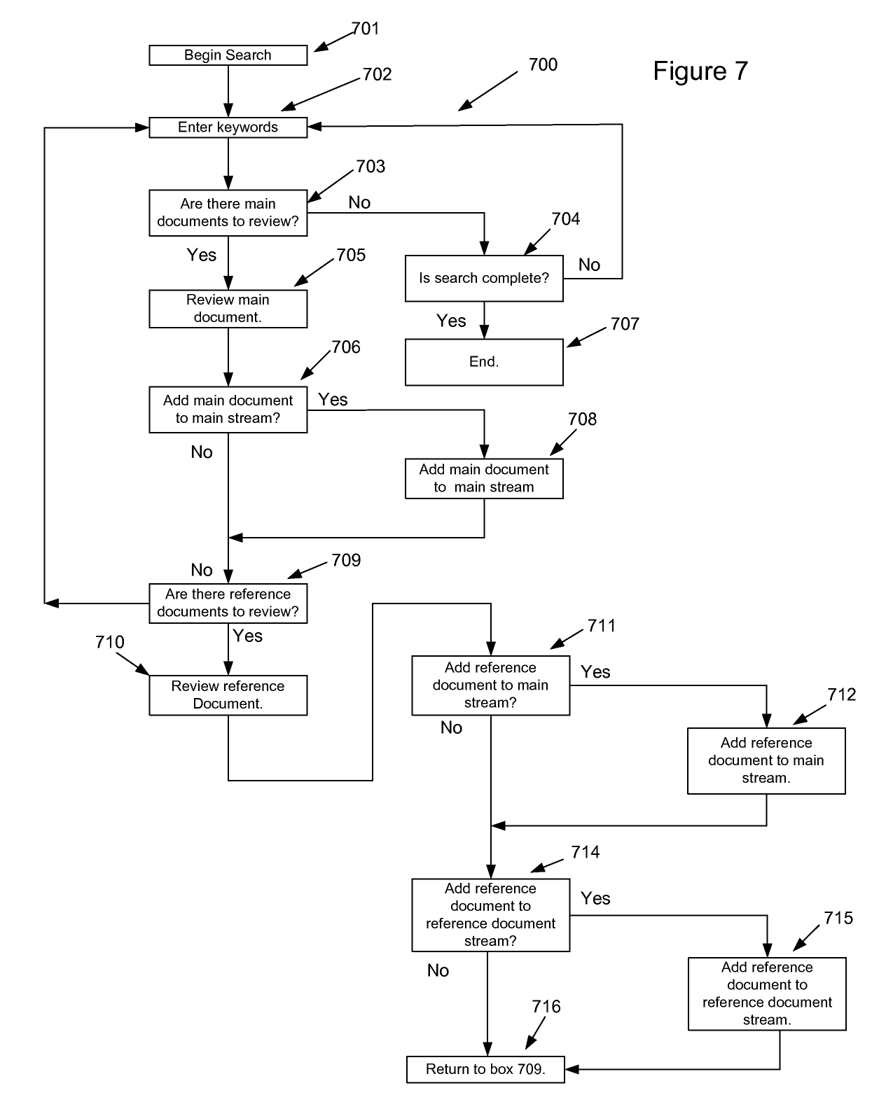

FIG. 7 is a flow chart 700 illustrating one embodiment of the operation of the present invention.

In box 701, a researcher initiates a document search by entering keywords in box 702.

In box 703, a decision is made whether there are any main documents to review in response to the search request. If no, the process continues to box 704 where a decision is made whether the search is complete. If yes, the process returns to box 702 where a new search inquiry can be made. If no, the search process ends in box 707.

If the search request resulted in a main document to review, the document is reviewed in box 705 and the process continues to box 706.

In box 706, a decision is made whether the just reviewed main document should be added to the main document stream. If yes, the document is added to the main document stream in box 708 and the process continues to box 709.

In box 709, a decision is made whether the just reviewed main document cites reference documents that should be reviewed. If yes, the first reference document is reviewed in box 710 and the process continues to box 711.

In box 711, a decision is made whether the just reviewed reference document should be added to the main document stream. If yes, the reference document is added to the main document stream in box 712 and the process continues to box 714. If the just reviewed reference documents is not to be added to the main document stream, the process continues directly to box 714.

In box 714, a decision is made whether the just reviewed reference document should be added the reference document stream. If yes, the reference document is added to the reference document stream in box 715 and the process returns to box 709 so that the next reference document can be reviewed.

If the just reviewed reference document is not be added to the reference document stream, the process also returns to box 709.

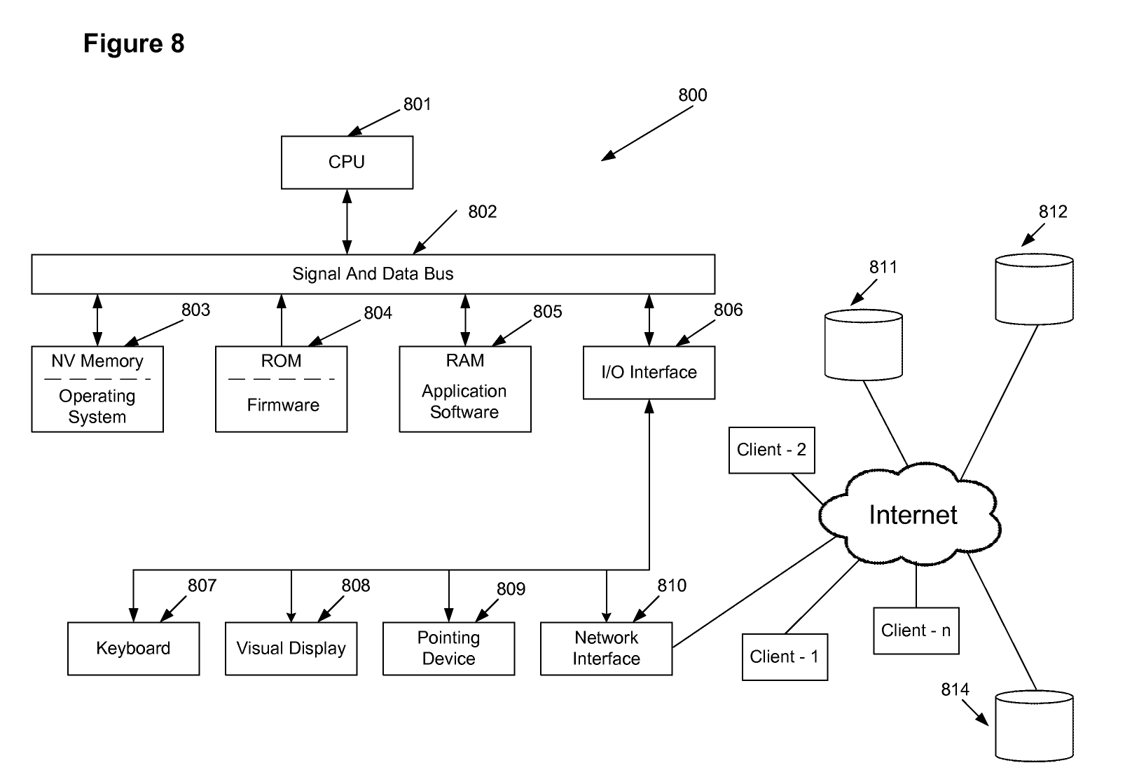

FIG. 8 is a block diagram that illustrates the basic components of a computer portal 800 that may be used to implement the search and document review system of the present invention.

The system includes a CPU 801. The CPU is used for executing computer software instructions as is known in the art. CPU 801 is coupled to a number of other elements via a signal and data bus 802 as is also known in the art. These elements include ROM (Read Only Memory) 804 which may be used to store computer software instructions, RAM 805 (Random Access Memory) which also may be used to store computer software instructions, I/O Interface 806 which may be used to interface CPU 801 to elements and/or functions that are external to CPU 801, and Non Volatile Memory 803 which may be used to store computer software instructions as well. As mentioned above, I/O Interface 806 is used to interface CPU 801 to elements or functions that are external to the CPU. These external elements might include Keyboard 807, Visual Display 808, Pointing Device 809, and Network Interface 810.

Depending on the tasks to be performed by CPU 801, its computer software instructions might be divided into two or more separate and distinct categories which are stored in separate portions of ROM 804, RAM 805 and/or Non Volatile Memory 803. In some devices, a basis set of low level operating instructions, known in the art as firmware, might be stored in, for example, ROM 804. These low level rudimentary instructions provide the necessary instructions for how the controller communicates with the other computer hardware. Such instructions are necessary for the controller to perform any useful work, regardless of the application for which the device is to be used.

The computer instruction set that is executed by CPU 801 to perform the particular tasks required of the controller is often called “application software” and operationally “sits” on top of the firmware.

As illustrated in FIG. 8, the application software is stored in RAM 805. The application software could also be stored in ROM 804 or in Non Volatile Memory 803.

The firmware allows application software to efficiently interface with the other device hardware, such as the elements that are coupled to CPU 801 via I/O Interface 806.

Again, depending on the tasks to be performed by CPU 801, a third set of software instructions known in the art as an operating system might operationally “sit” between the firmware and application software. The operating system is shown as being stored in Non Volatile Memory 803 in FIG. 8 but could be stored in RAM 805 as well.

Network interface 810 is allows the portal to be connected to the Internet, or to other networks, such as local area or wide area networks. Similarly attached to the

Internet, or local or wide area networks are plurality of databases 811, 812 and 814. These databases store the research documents, or link to such documents, that researchers can review and add to their main or reference document stream.

Researchers access the portal through client computer devices also attached to the network, such as clients 1-n. Client devices may be a desktop or laptop PC, tablet or smart phone running an appropriate software application.

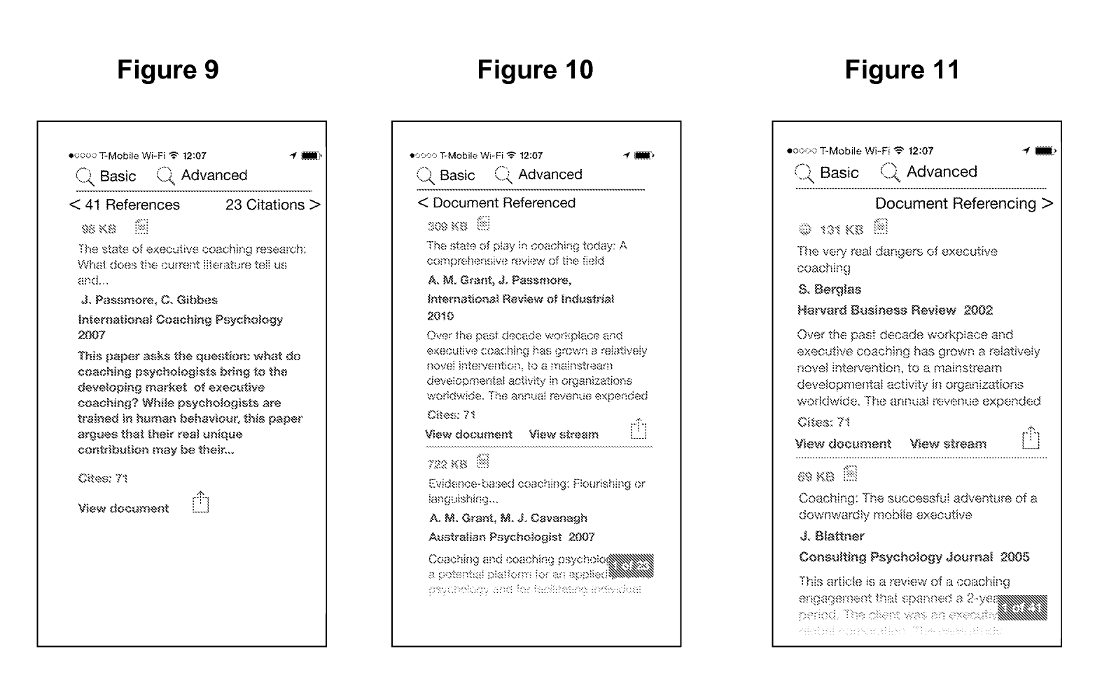

FIGS. 9-11 are screen shots of a client smart phone using the system of the present invention displaying document search results in one embodiment of the present inventions.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A research method for displaying a plurality of related data objects in a research stream back and forth in time, said method comprising the steps of:
selecting from a database, by a computer system, a main data object having a creation date, said main data object being related to a plurality of reference data objects, each reference data object having a reference date to said main data object;
storing in a database, by a computer system, said selected main data object in an electronic research stream stored in a database;
storing in a database, by a computer system, said plurality of reference data objects in said research stream associated with said selected main data object;
repeating said selecting and said storing steps a plurality of times;
displaying to the user a selected one of said main data objects within said research stream along with its associated reference data objects.

2. The research method of claim 1, further including the step of:
organizing, by a computer system, said reference data objects in chronological order according to their respective said reference dates.

3. The research method of claim 2, further including the step of:
displaying to the user said reference data objects in a first group having reference dates prior to said creation date of said selected main data object and a second group having reference dates after said creation date of said main data object.

4. The research method of claim 3, wherein said reference data objects in said first and second groups are arranged in chronological order.

5. The research method of claim 3, wherein said reference data objects in said first and second groups are arranged in reverse chronological order.

6. The research method of claim 1, further comprising the step of:
scrolling, by a computer system, along said research stream back and forth in time to allow a user to select a main data object for viewing.

7. The research method of claim 1, further including the step of:
organizing, by a computer system, said selected main data objects in said research stream in chronological order according to their respective creation dates.

8. The research method of claim 7, further comprising the step of:
scrolling, by a computer system, along said research stream back and forth in time to allow a user to select a main data object for viewing.

9. The research method of claim 8, further comprising the step of:
scrolling, by a computer system, along said research stream back and forth in time to allow a user to select a reference data object for viewing.

10. The research method of claim 9, further comprising the step of:
displaying, by a computer system, said selected reference data object to the user along with its associated reference data objects, wherein said reference data objects then become a main data object.

11. The research method of claim 10, further comprising the step of:
user selection, by a computer system, between said step of scrolling along said research stream back and forth in time to allow a user to select a main data object and said step of scrolling along said research stream back and forth in time to allow a user to select a reference data object.

12. The research method of claim 1, wherein said main data objects and said reference data objects are stored in said database as electronic links to a remote storage location.

13. The research method of claim 1, wherein said main data objects are research documents.

14. The research method of claim 1, wherein said reference data objects are research documents.

15. The research method of claim 1, wherein said main data objects are electronic communication contacts.

16. The research method of claim 1, wherein said reference data objects are electronic communication contacts.

17. The research method of claim 1, wherein said main data objects are electronic mail.

18. The research method of claim 1, wherein said reference data objects are electronic mail.
